(19) United States
(12) Patent Application Publication
(10) Pub. No.: US 2008/0288337 A1
(43) Pub. Date: Nov. 20, 2008

(54) Template-Based Targeted Marketing

(76) Inventors: John Snyder, Bellbrook, OH (US); Karen Payne, Brookville, OH (US); Jennifer Michael, Germantown, OH (US); Rebecca Sroufe, Germantown, OH (US); Lauren Vore, Tipp City, OH (US); Linda Domi, Kettering, OH (US); Merle Carr, Kettering, OH (US); Chad Anderson, LaCrosse, WI (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/694,151

(22) Filed: Mar. 30, 2007

Related U.S. Application Data
(60) Provisional application No. 60/873,733, filed on Dec. 8, 2006.

(51) Int. Cl. G06Q 30/00

(52) U.S. Cl. 705/14; 705/1

(57) ABSTRACT

Systems, methods, and computer-readable media provide for the creation of a template-based targeted marketing presentation. According to various embodiments described herein, a sales representative utilizes a workstation to request a marketing presentation for a certain category of customer within a particular market. A presentation engine retrieves applicable up-to-date data corresponding to the customer category and market from a database and uses the data to make one or more Return On Investment (ROI) calculations. One or more presentation templates include data insertion locations. The one or more ROI calculations and other retrieved data is used to populate the data insertion locations of a selected presentation template. Once populated, the resulting marketing presentation is customized with targeted data and statistics for presenting to the customer.

### CROSS REFERENCE TO RELATED APPLICATIONS

The present application claims priority under 35 U.S.C. §119 to co-pending U.S. provisional application No. 60/873,733 entitled “Methods, Systems, and Computer-Readable Media for Promoting Advertisement Sales” filed on Dec. 8, 2006, and which is expressly incorporated herein by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

This application relates generally to marketing. More particularly, this application relates to improving marketing effectiveness through creating a targeted marketing presentation using a presentation template and up-to-date collateral data.

### BACKGROUND

Having an efficient and effective marketing strategy is a critical component to the operation of many businesses. This is particularly true for businesses that rely on selling a service that may not provide an instantly tangible result for the customer making the purchase. For example, companies that sell advertising in a physical medium such as a telephone book or an electronic medium such as the Internet need to be able to demonstrate to a potential advertiser that purchasing an advertisement will result in increased sales for the advertiser. By showing a potential advertiser a favorable Return On Investment (ROI), or how much the advertiser can expect to financially benefit in comparison with the investment associated with purchasing the advertisement, the sales representative is more likely to persuade the potential advertiser to purchase an advertisement.

Existing marketing strategies rely on a great deal of preparation on the part of a sales representative in order to determine a customer's ROI prior to making contact with the customer. The sales representative may collect pertinent data relating to a product, service, market, and/or the customer and calculates ROI statistics corresponding to the customer. This process is time consuming as the sales representative gathers data from multiple sources and manually performs the necessary ROI calculations and then uses the collected data and calculation results to build a presentation for the customer.

This method additionally creates a potential for errors due to the varying quantities of data and associated calculations. Moreover, the data used to calculate the ROI statistics is often compiled into visuals on a scheduled periodic basis to be printed by sales representatives as needed. Accordingly, by using data that was compiled into a visual at a pre-determined time in the past, there is a likelihood that the data is not the most current data available. Finally, the existing method of creating marketing presentations does not allow for the flexibility to input new data or change existing data while speaking to a customer in order to demonstrate a customer's expected ROI under various conditions.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer-readable media are provided herein for creating a targeted template-based marketing presentation. According to embodiments described herein, a marketing category is received and used to retrieve data that is associated with the category. Business data associated with a customer may also be received. One or more marketing estimates corresponding to the customer's business are calculated using the data associated with the marketing category and the business data. The data associated with the marketing category may include a customer conversion rate, an average customer worth, and an average profit per customer. The one or more marketing estimates and other associated data are used to populate a presentation template for presenting to the customer.

According to further embodiments of the disclosure provided herein, the marketing estimates correspond to Yellow Pages and Internet advertising. The marketing category may correspond to a Yellow Pages category heading of products or services. In addition to receiving a marketing category, a market selection may also be received prior to retrieving the data to be used in calculating the marketing estimates. The market selection may correspond to a specific geographic area. Accordingly, data corresponding to the marketing category and the selected market is then retrieved for use in calculating one or more marketing estimates. In this manner, the marketing estimates are more specifically targeted to a customer operating under the market category in the selected market. According to various embodiments, the marketing estimates include ROI estimates.

Other systems, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram showing elements of an illustrative marketing system according to various embodiments presented herein;

FIG. 2 is a user interface diagram showing data input fields to be used by a sales representative in creating a marketing presentation according to various embodiments presented herein;

FIGS. 3A-3U are presentation slides showing an illustrative marketing presentation created using a presentation template, collateral data, and corresponding ROI estimates according to various embodiments presented herein;

FIGS. 4A-4D are flow diagrams illustrating a method for creating a targeted marketing presentation according to various embodiments presented herein; and

FIG. 5 is a computer architecture diagram showing a computer architecture suitable for implementing the various computer systems described herein.

### DETAILED DESCRIPTION

The following detailed description is directed to systems, methods, and computer-readable media for creating a targeted marketing presentation using a presentation template in combination with targeted collateral data and calculated marketing estimates. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The subject matter described herein may be practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices.

As stated briefly above, embodiments described herein allow a sales representative to efficiently and accurately create a marketing presentation that increases the sales representative's likelihood of selling a product or service to a customer. Throughout this disclosure, embodiments will be described with respect to a sales representative selling advertising space in a core Yellow Pages directory, in any available companion directories, and in an Internet directory. However, it should be understood that the present disclosure may be implemented in any number of businesses utilizing sales representatives marketing a product or service to a potential or existing customer. It should also be understood that the term “presentation” may include any document, electronic or paper, that includes marketing information to be presented to a potential or existing customer.

According to various implementations described herein, a sales representative utilizes a workstation to request a marketing presentation for a certain category of customer within a particular market. A presentation engine retrieves applicable up-to-date information corresponding to the customer category and market from a database and uses the information to make marketing calculations and to subsequently populate a presentation template. It should be appreciated that the marketing calculations may result in any type of information to be used in targeting the sale of a product or service to a specific business or type of business, including but not limited to ROI estimates. Once populated, the resulting presentation is customized with targeted data and statistics for presenting to the customer. The embodiments described herein reduce the amount of time required for a sales representative to prepare and plan for a sales call or visit with a customer while providing accurate and up-to-date information that increases the likelihood of a successful sale.

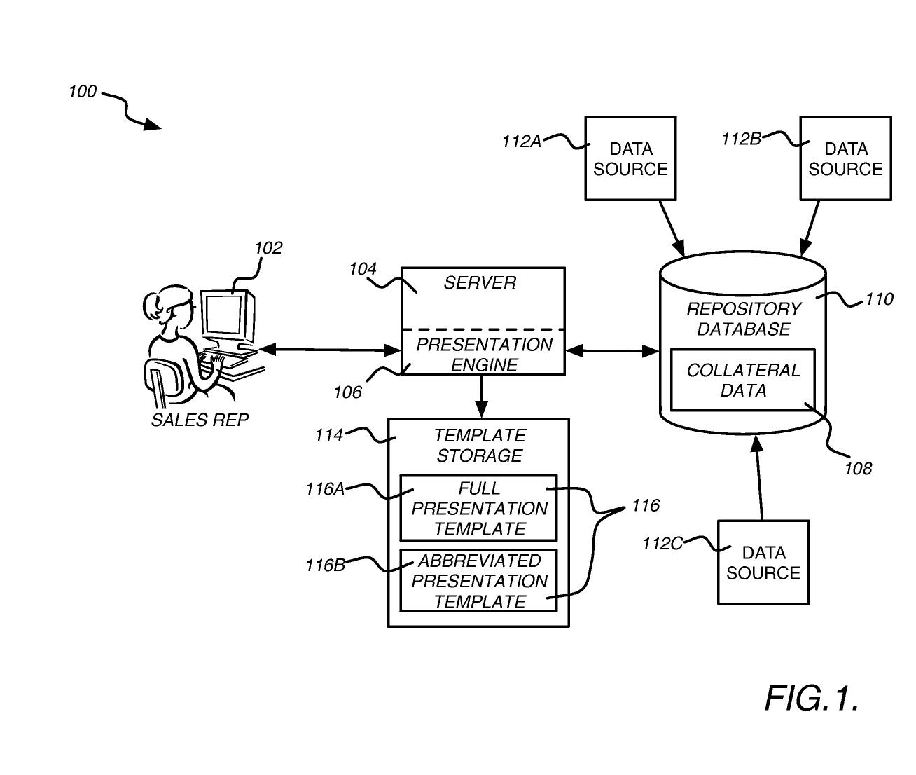

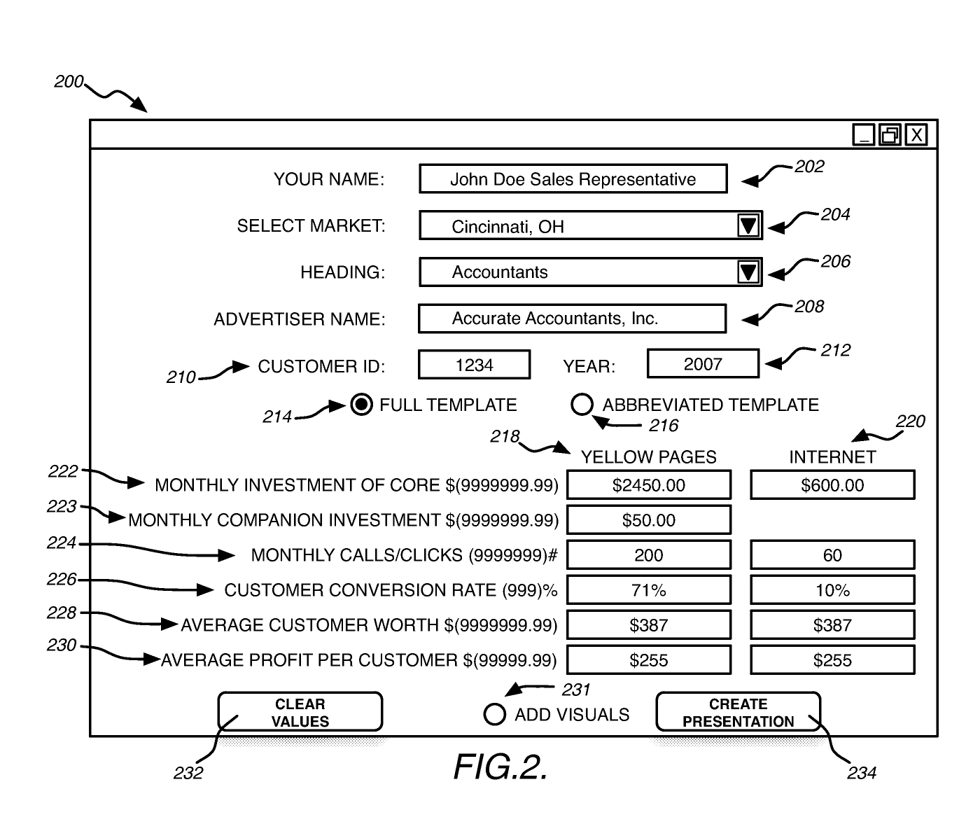

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing a targeted template-based marketing presentation will be described. FIG. 1 shows various elements of a marketing system 100 according to embodiments described herein. The marketing system 100 will be described briefly with respect to FIG. 1 and will be described in greater detail below with respect to FIGS. 2-5.

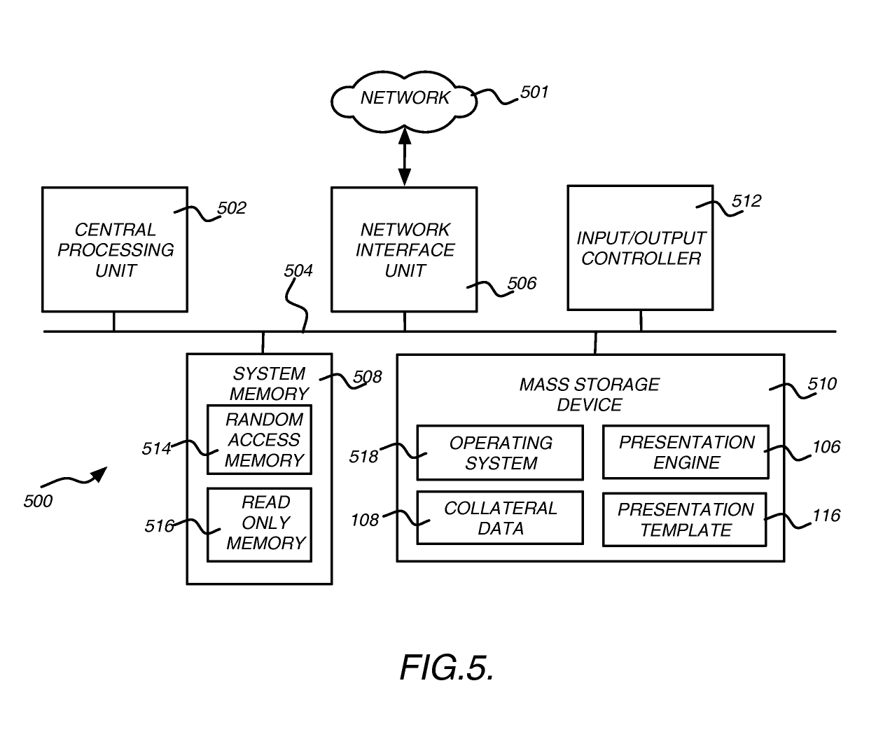

The marketing system 100 includes a workstation 102 that is utilized by a sales representative to create a targeted marketing presentation. The workstation 102 communicates with a server 104. It should be appreciated that the communication between the workstation 102 and the server 104, as well as the communication between any of the elements of the marketing system 100, may occur via a wired or wireless network. The network will be described in greater detail below with respect to FIG. 5. The server 104 executes a presentation engine 106 that receives input from the workstation 102 and retrieves and compiles data from other elements of the marketing system 100 to create a targeted marketing presentation. It should be appreciated that the presentation engine 106 may be an application located within the server 104, within the workstation 102, or may be remotely executed by the server 104 or the workstation 102.

Specifically, the presentation engine 106 retrieves collateral data 108 from a repository database 110 and utilizes the collateral data 108 to complete a presentation template 116 and create a marketing presentation that is targeted to a specific category of customers within a specific market. It should be understood that the presentation template 116 may include a full presentation template 116A, an abbreviated presentation template 116B, or any other type of presentation template that is available to a sales representative. The presentation template 116, and specifically the full presentation template 116A and the abbreviated presentation template 116B will be discussed in greater detail below.

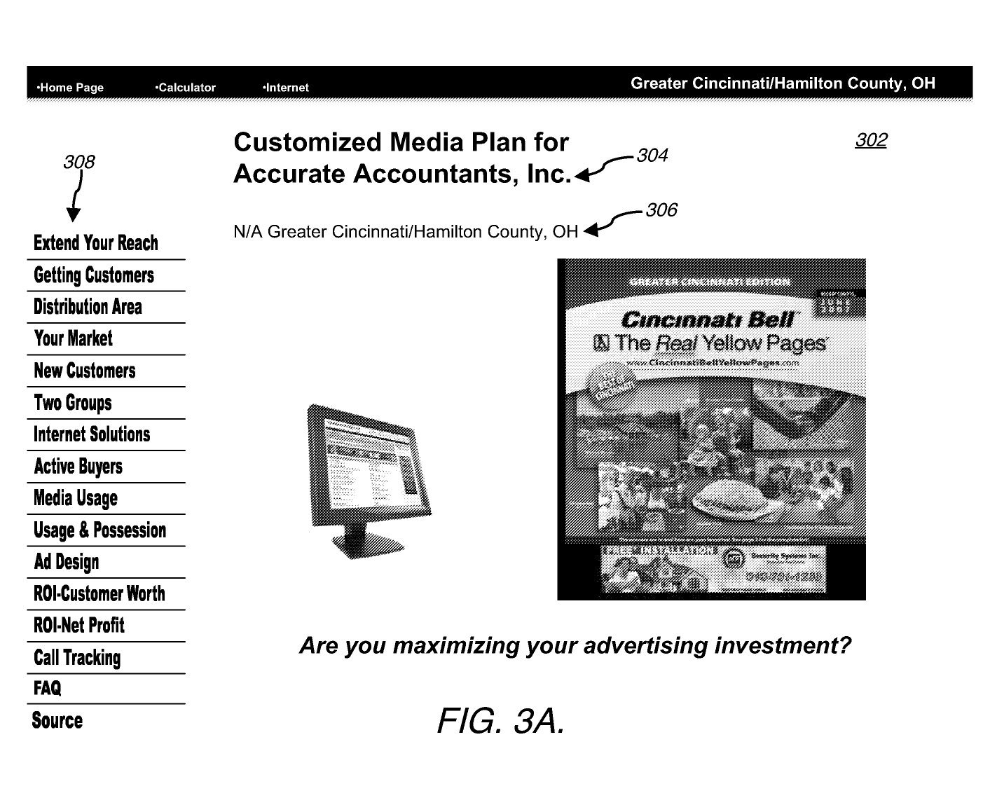

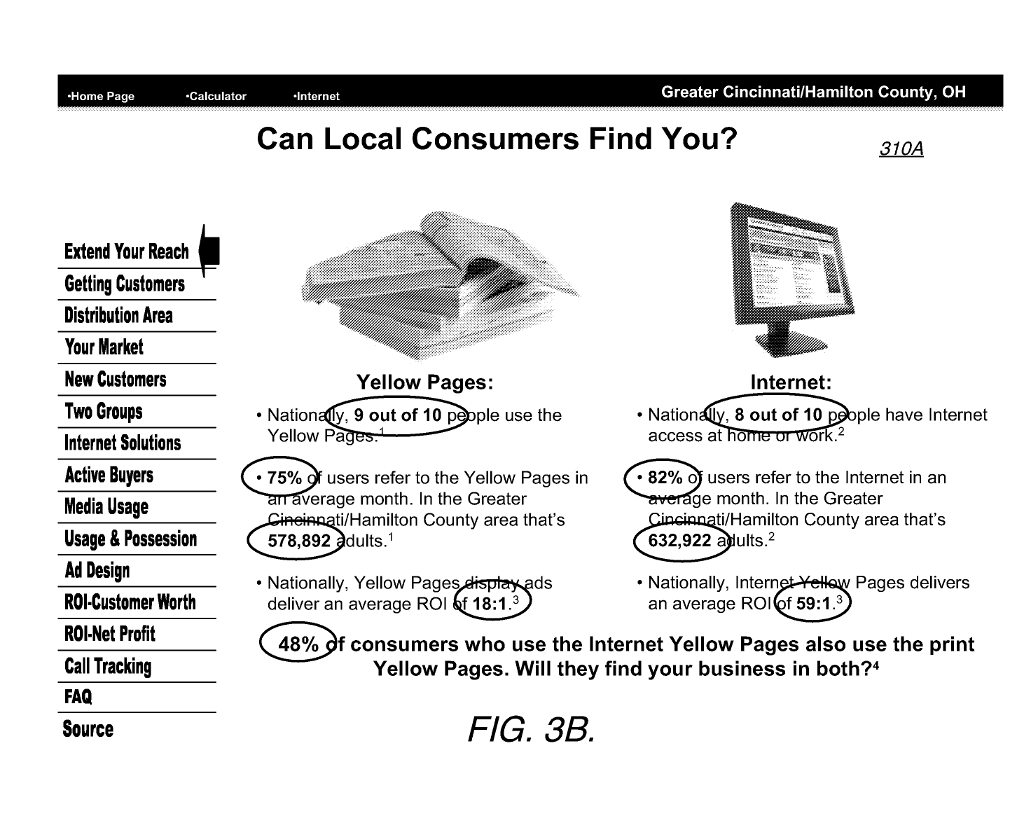

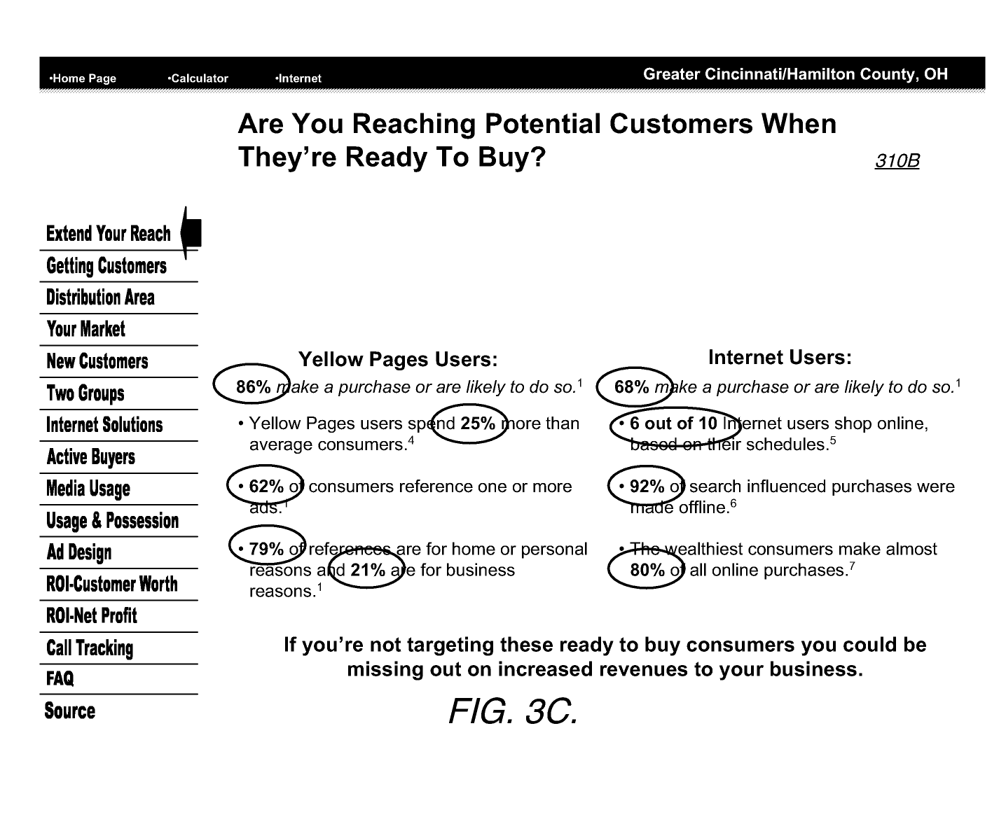

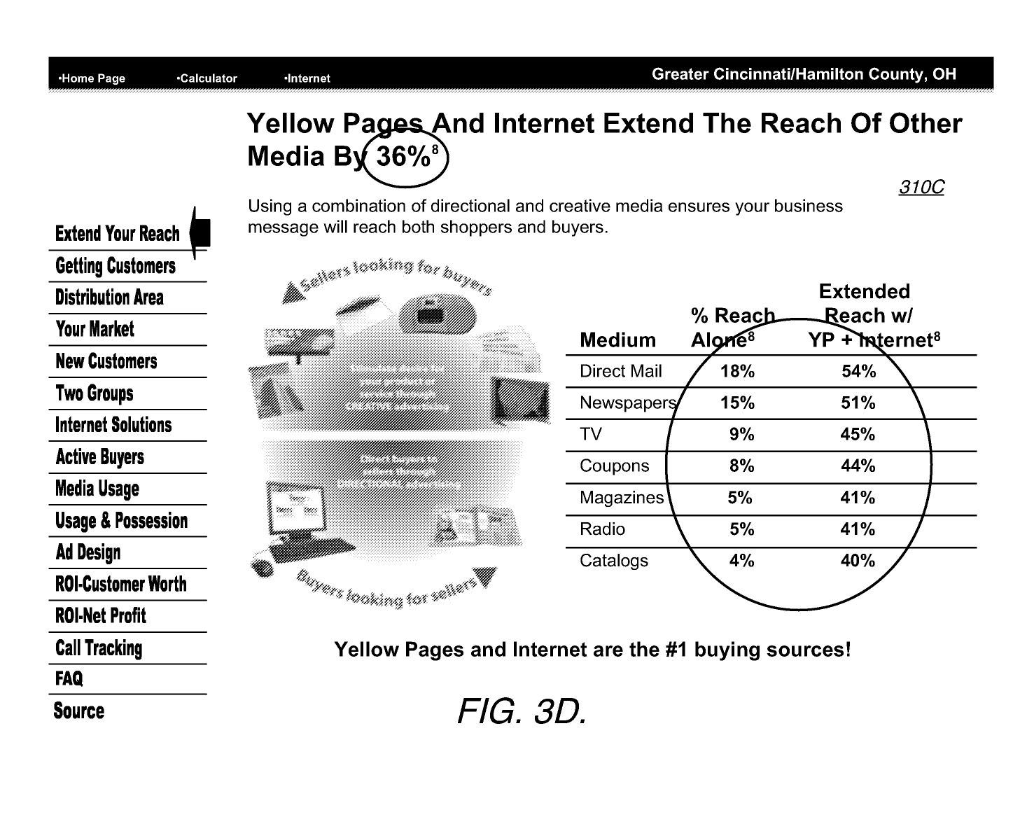

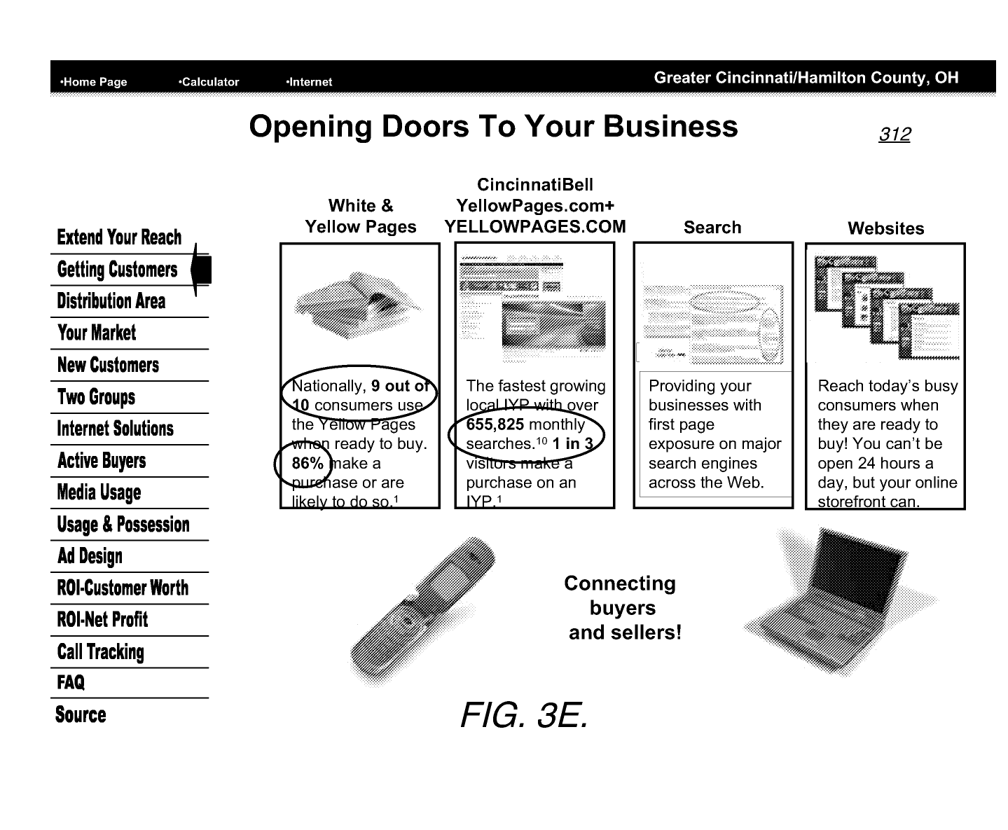

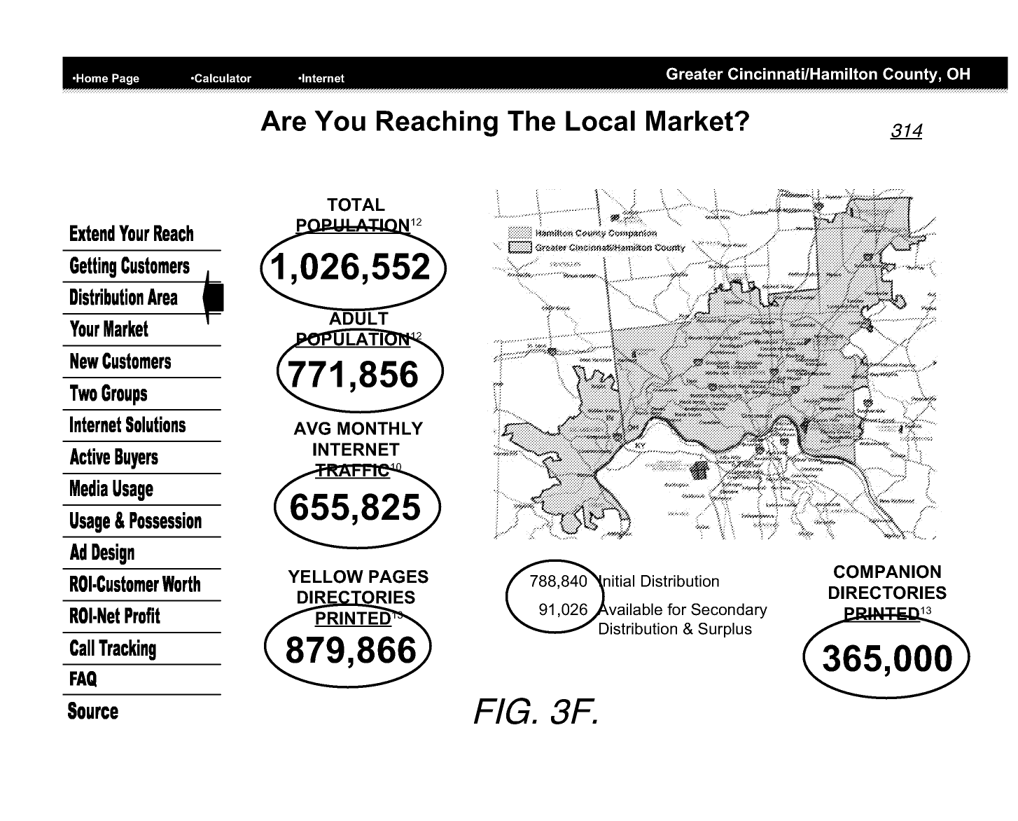

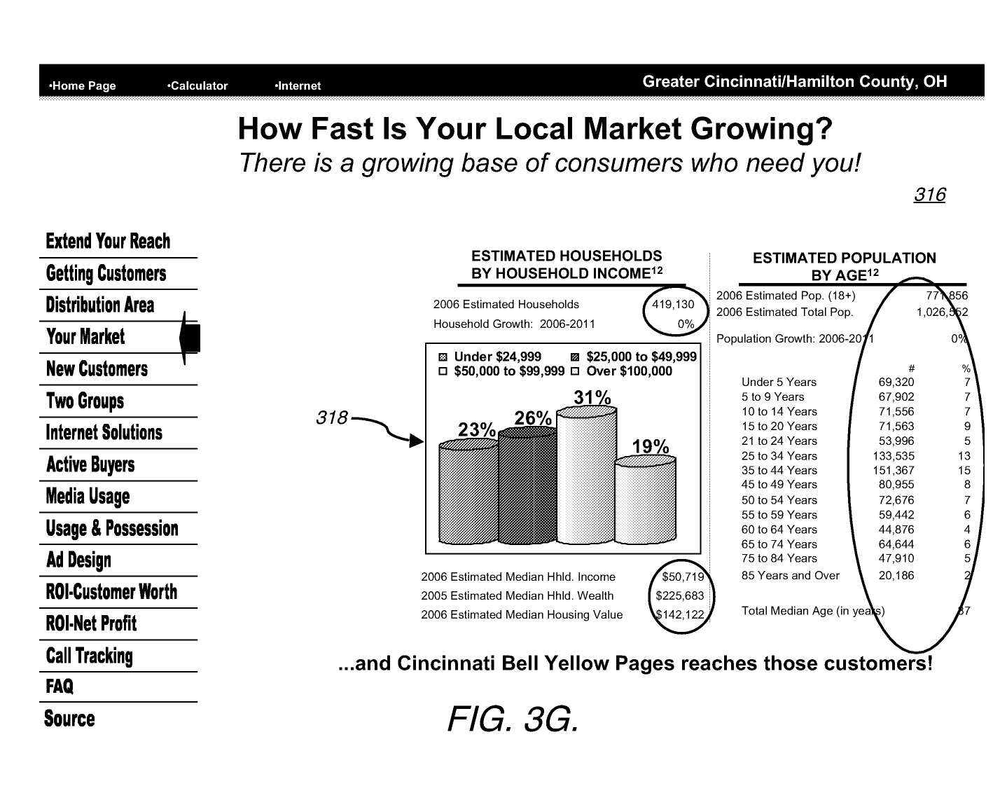

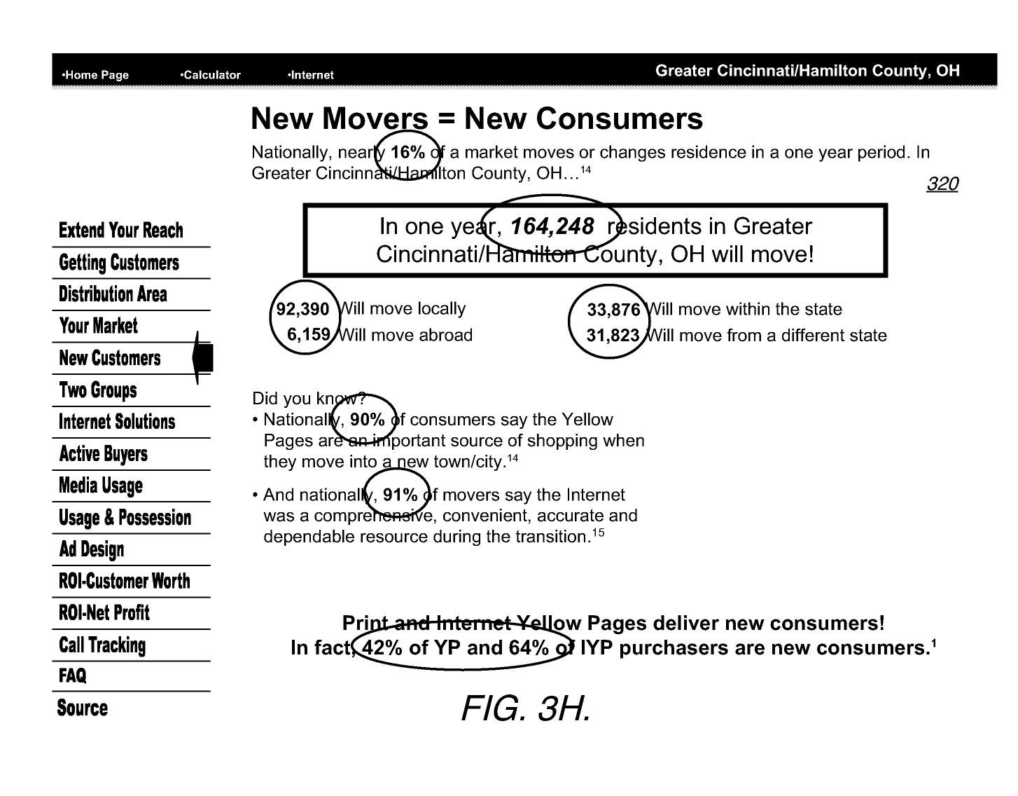

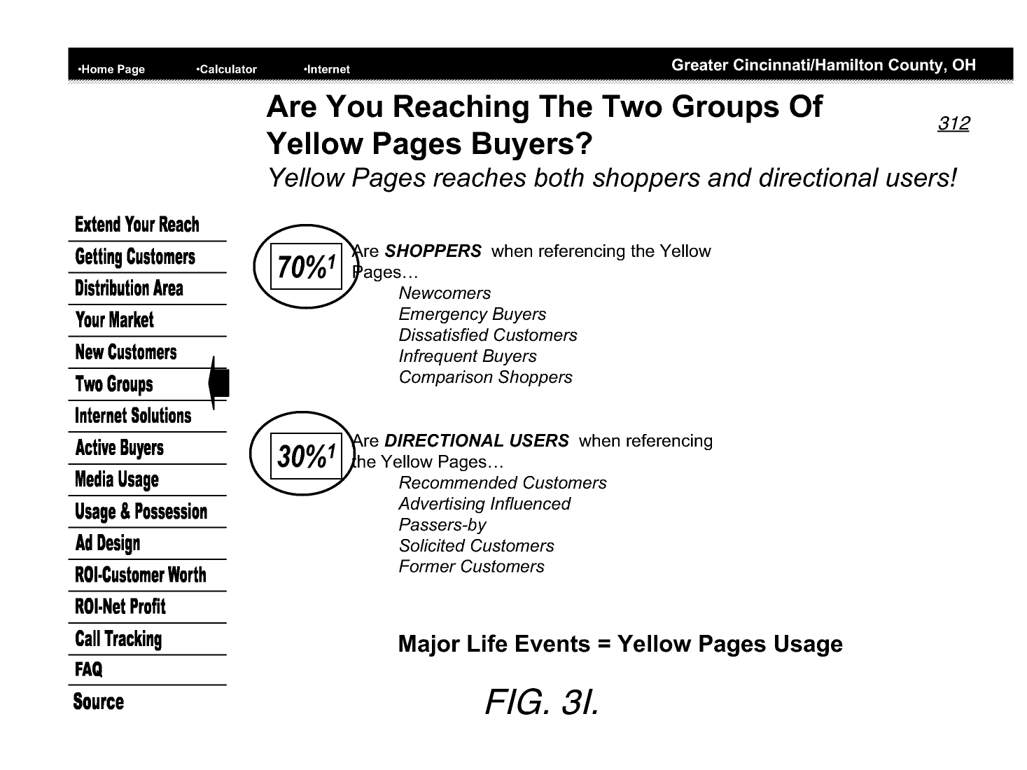

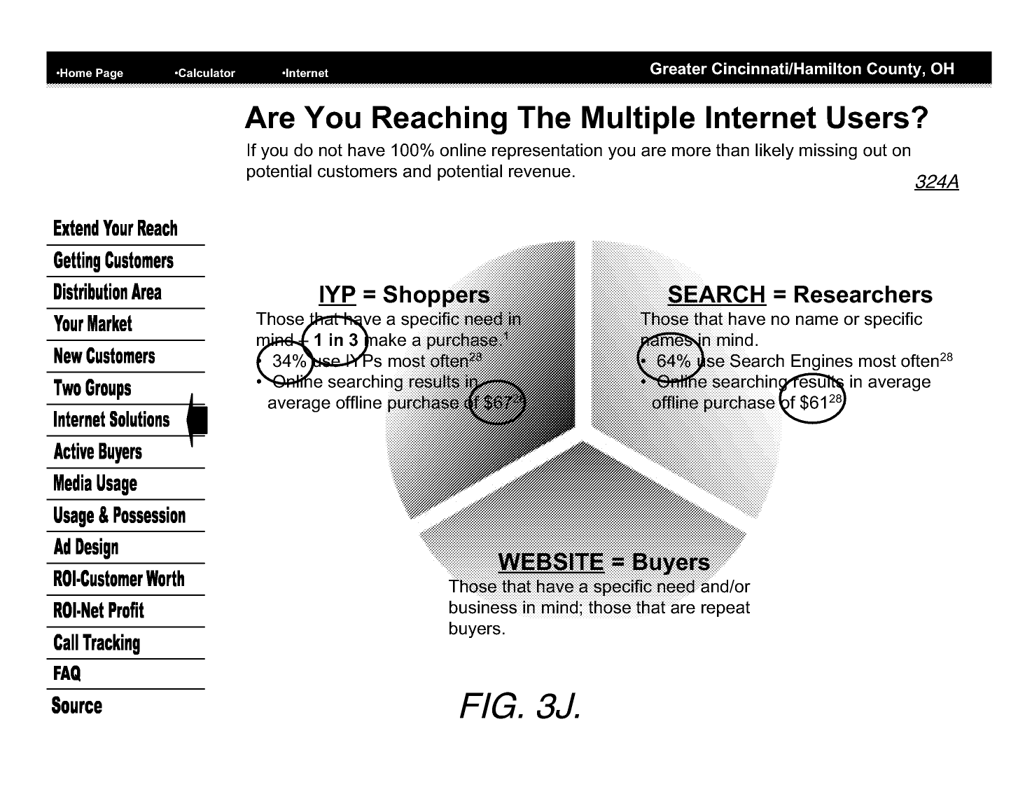

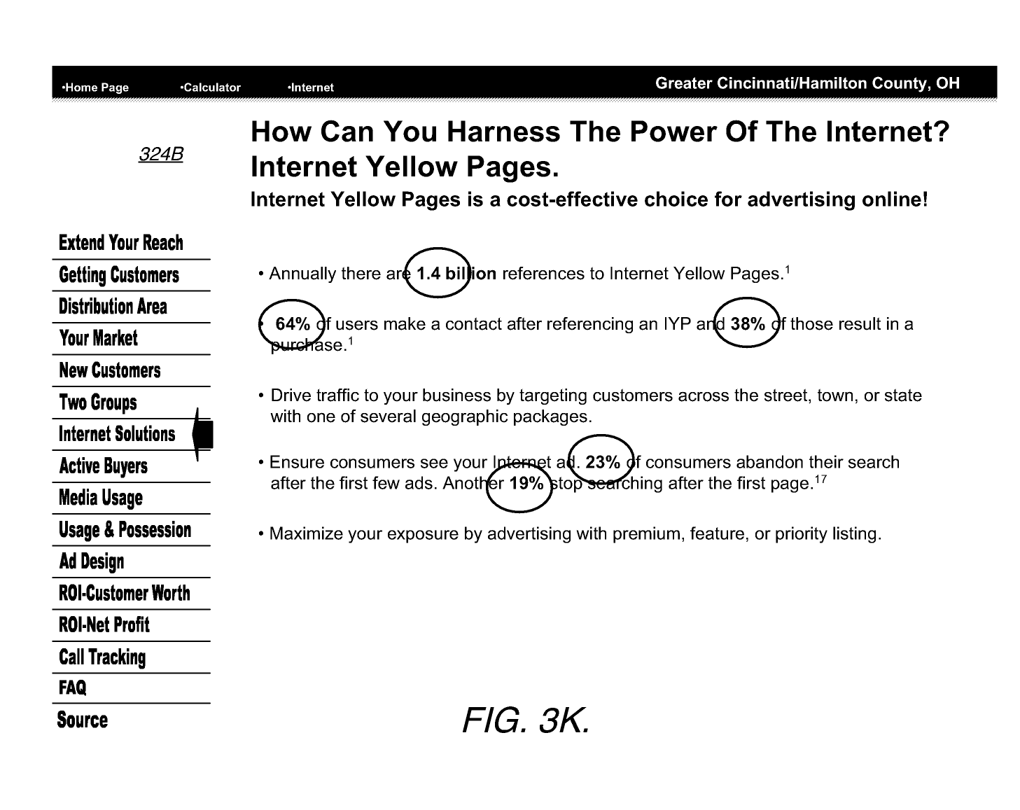

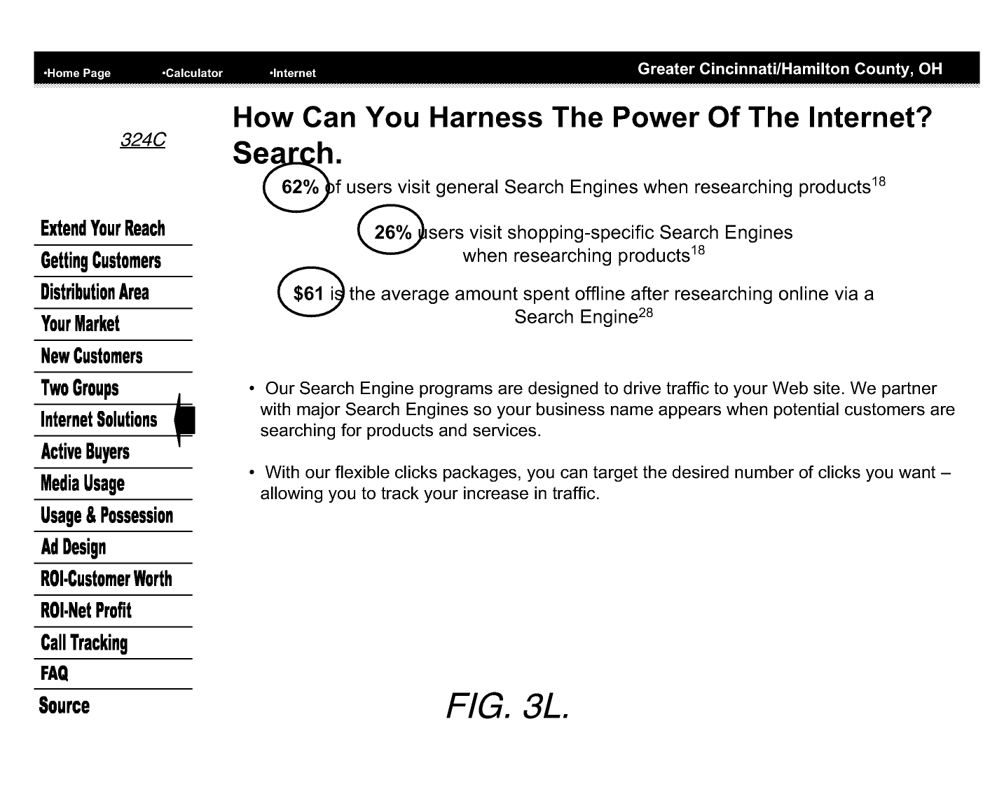

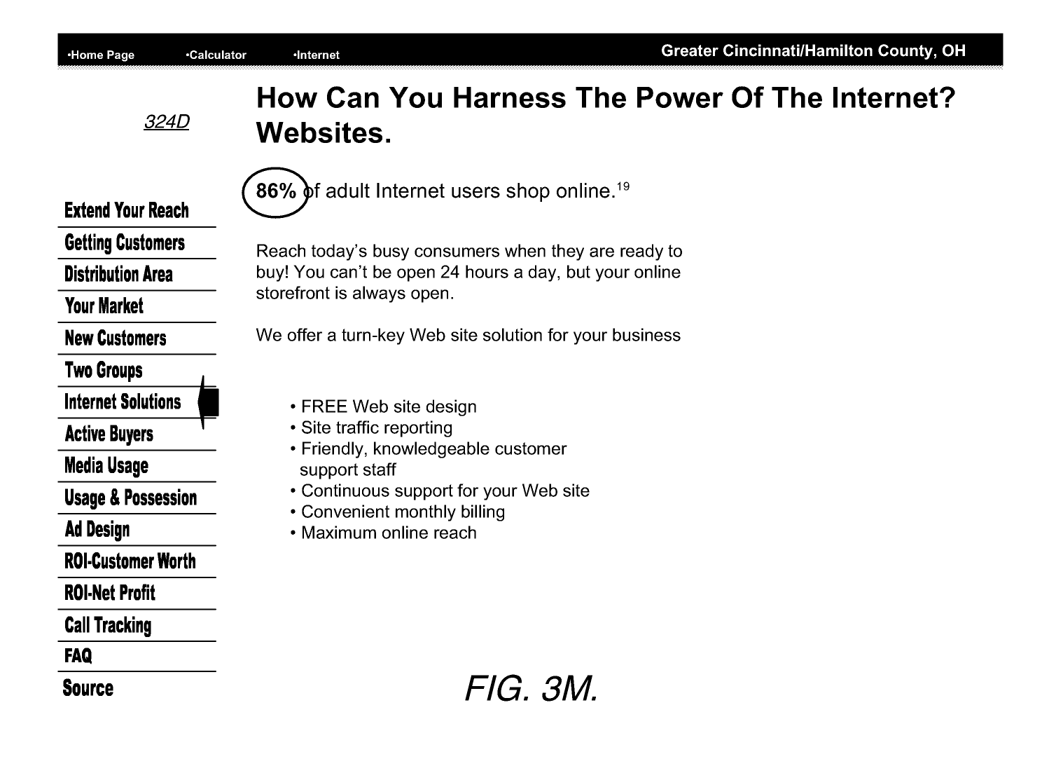

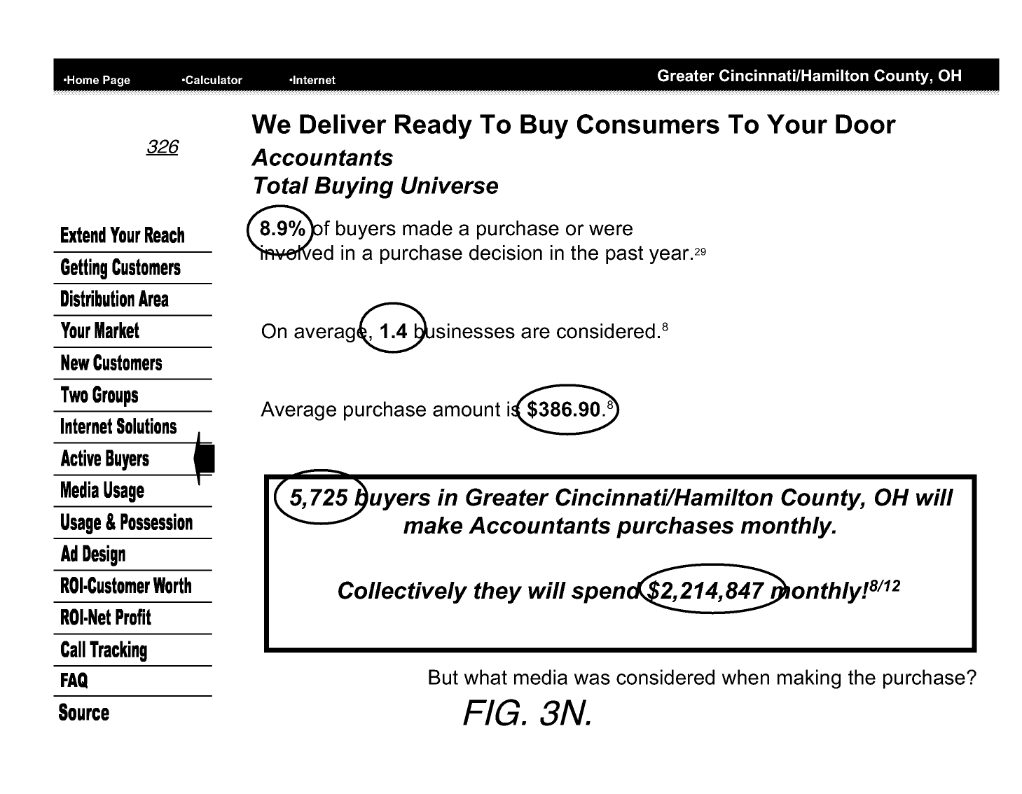

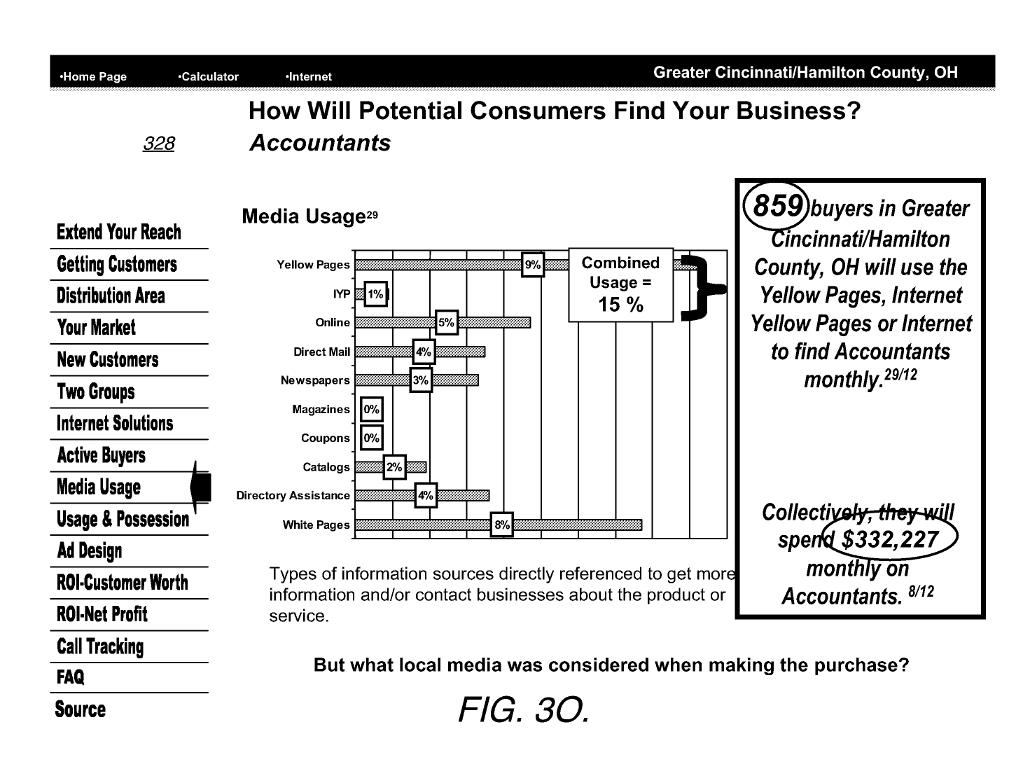

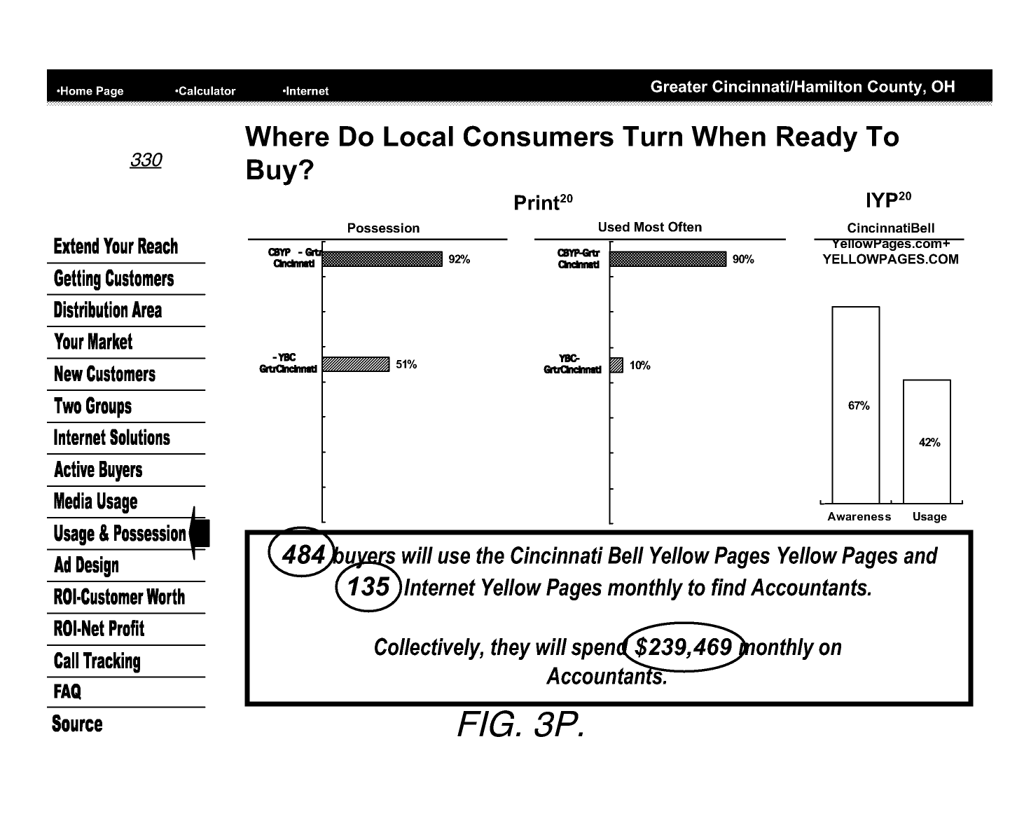

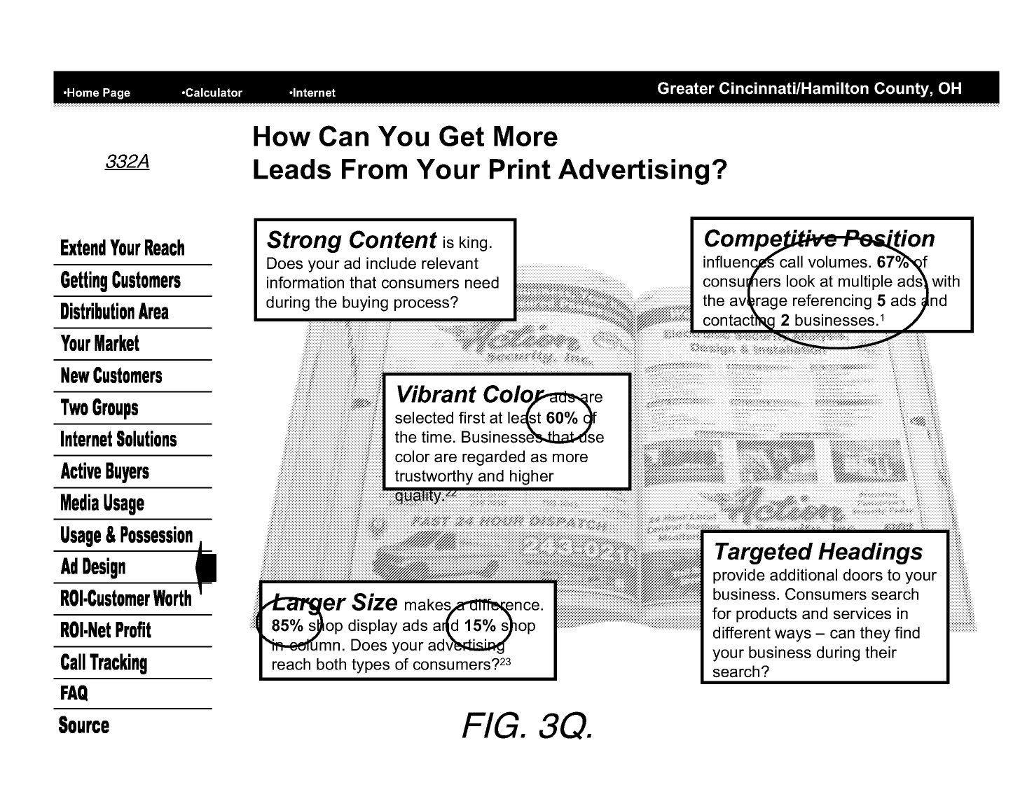

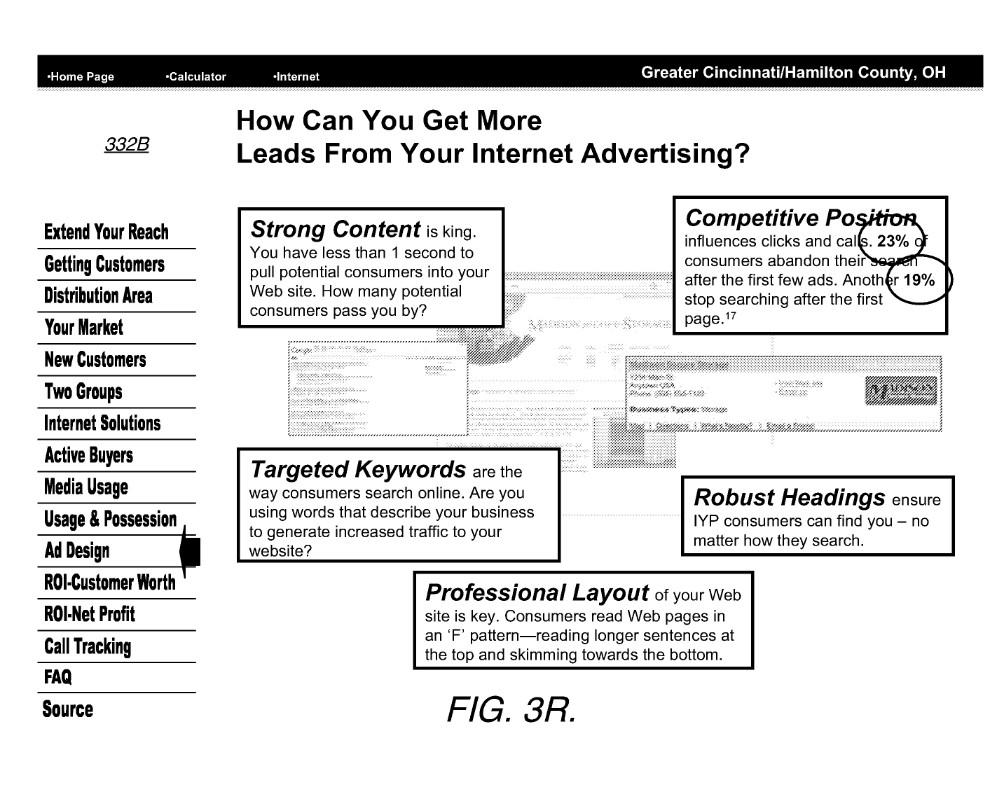

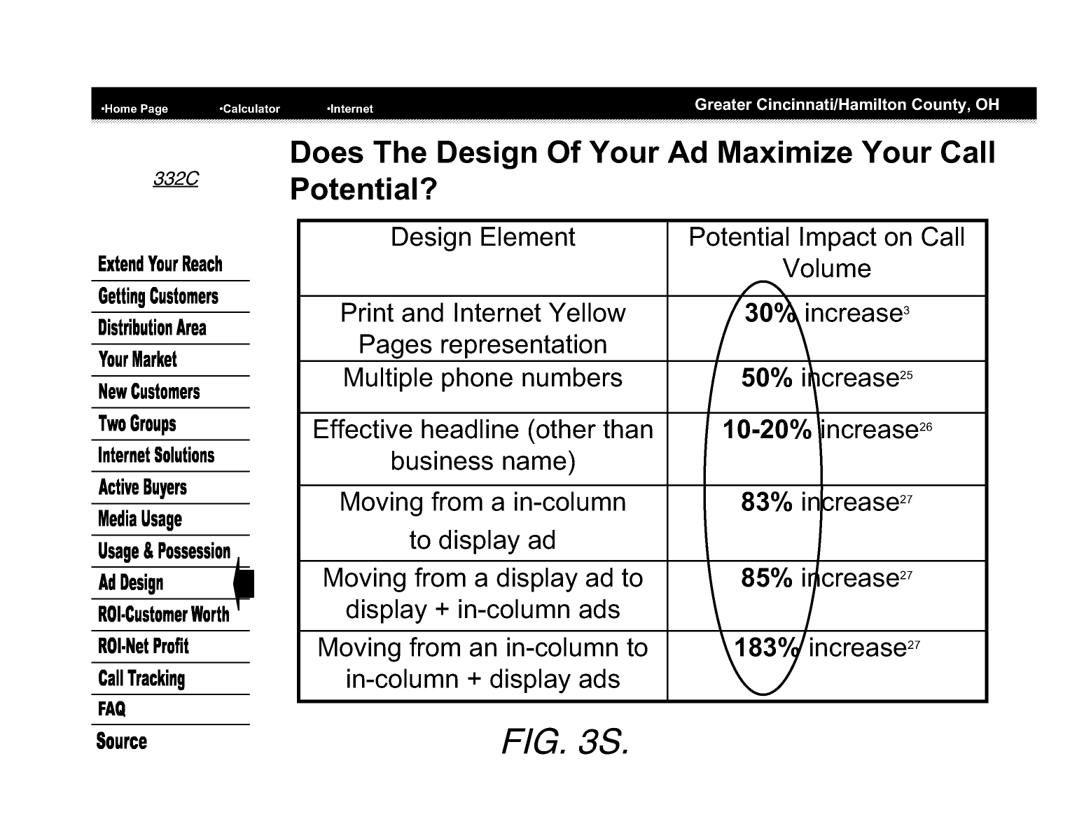

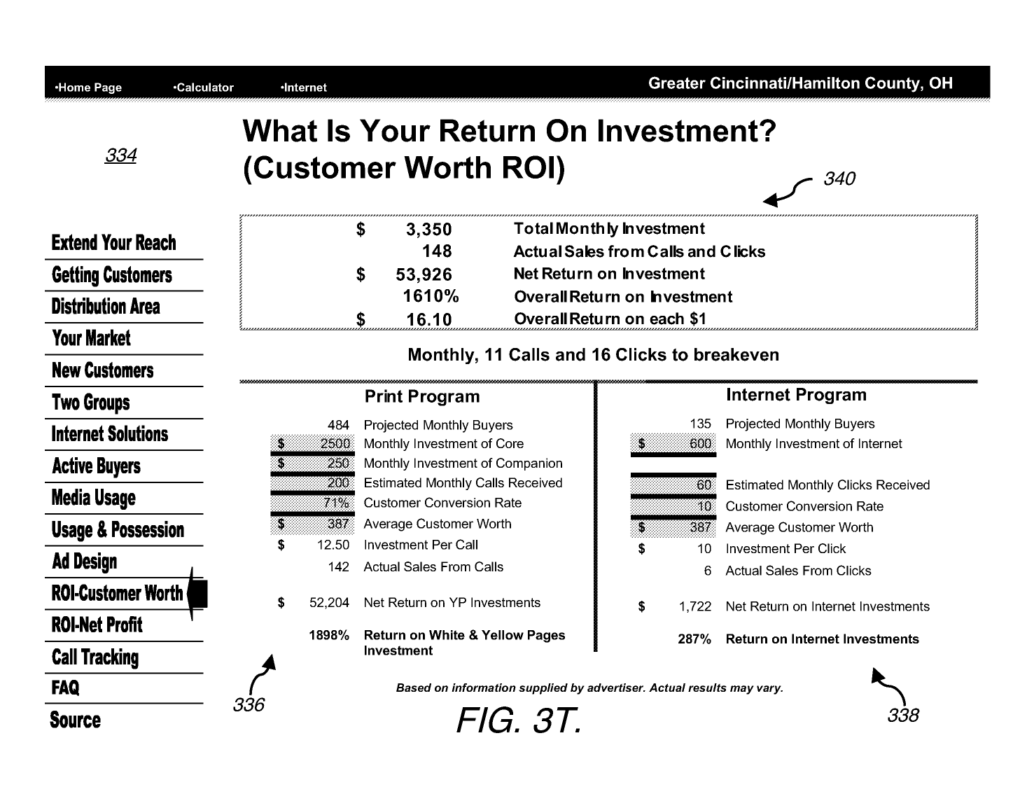

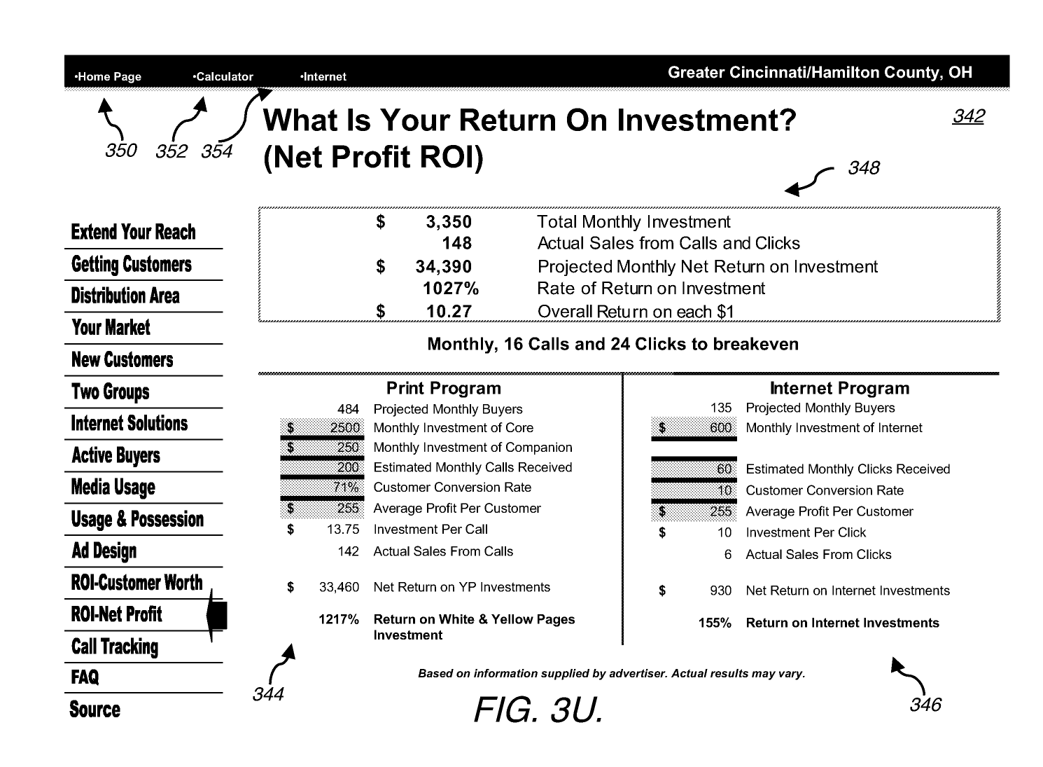

The collateral data 108 includes any data that relates to a particular market, a customer category, and/or a customer. Examples include but are not limited to population data, demographic data, number of potential buyers in a market, average purchase amount, the types of media that the population within market has and is using, the factors considered by consumers within the market when making a purchase, the average number of monthly calls and Internet transactions for a business within a customer category or market, customer conversion rates, average customer worth, and average profit per customer. Additionally, the collateral data 108 may include ROI data such as total monthly investment of print and Internet advertisements, actual sales statistics from calls and Internet transactions, and other ROI data corresponding to print and Internet advertisements. It should be appreciated that the collateral data 108 may be any type of data, including image data. The collateral data 108 and its use will be described in greater detail below with respect to the illustrative marketing presentation shown in FIGS. 3A-3U.

It should be understood that any type and amount of collateral data 108 may be collected and stored in the repository database 110 depending on the desired contents of the presentation template 116 and resulting marketing presentation. Although three data sources 112A, 112B, and 112C are shown in FIG. 1, it should be appreciated that the collateral data 108 may be collected from any number of data sources 112A, 112B, and 112C. The data sources 112A, 112B, and 112C may include national and regional studies and research initiatives. Examples of the data sources 112A, 112B, and 112C include but are not limited to Media Impact Studies (MIS) conducted by TAYLOR NELSON SOFRES (TNS), media research provided by KNOWLEDGE NETWORK/SRI, or any other media research sources or actual customer data. Methods and systems for aggregating, retrieving, and delivering collateral data 108 are disclosed by U.S. Patent Application No. 2005/0055337 by Bebo et al., which is incorporated herein by reference in its entirety.

The amount and type of collateral data 108 that is retrieved from the repository database 110 by the presentation engine 106 depends not only on the information request made by the sales representative via the workstation 102, but also on whether the sales representative requests a full presentation or an abbreviated presentation. An abbreviated presentation may be used when the sales representative is conducting a telephone sales call rather than visiting a customer. Because people are typically less attentive on the telephone, it is important to limit the presentation to only the information that is deemed most important. For this reason, two types of presentation templates 116 may be created, a full presentation template 116A and an abbreviated presentation template 116B.

The full presentation template 116A may include any number of full templates that target a specific type of advertising. For example, there may be a full presentation template 116A corresponding to print and Internet advertising, a full presentation template 116A corresponding to only print advertising, and/or a full presentation template 116A corresponding to only Internet advertising. Similarly, the abbreviated presentation template 116B may include any number of abbreviated templates that target a specific type of advertising. It should be appreciated that any number and type of presentation templates 116 corresponding to specific customers, categories of customers, markets, targeted media types, or any other variable may be created and stored for future use by one or more sales representatives. The presentation templates 116A and 116B, and any others that may be created, are stored in a template storage 114.

It should be understood that the template storage 114 may be located within the repository database 110, within the server 104, within the workstation 102, or may be a separate storage entity as shown in FIG. 1. It should also be understood that although the server 104 is shown to be a single server computer, the server 104 may be any number of server computers. The workstation 102 may be separate from the server 104, or may alternatively be a single computer. Similarly, although one repository database 110 is shown, the collateral data 108 may alternatively be stored within multiple repository databases 110, or may be stored within a memory or mass storage device of one or more server computers, such as the server 104. The specific elements of the marketing system 100 are shown for illustration purposes only and may be configured according to any number of computing devices, applications, and databases according to various embodiments without departing from the scope of the disclosure presented herein.

Turning now to FIG. 2, a presentation request user interface 200 according to one implementation of the disclosure presented herein will be described. For illustration purposes, the information that is shown entered into the various fields of the presentation request user interface 200 corresponds to the illustrative marketing presentation shown below in FIGS. 3A-3U. Upon launching the presentation engine 106, the presentation request user interface 200 will be displayed on the workstation 102 for the sales representative. The presentation request user interface 200 includes a name field 202 for receiving the name of the sales representative creating the presentation. A market field 204 is provided for receiving the targeted market.

The targeted market may correspond to a geographical location in which the customer is interested in advertising. Alternatively, the market may correspond to a particular demographic or any other consumer classification corresponding to the group of people to which the advertisement may be targeted. It should be appreciated that the market field 204 or any other field within the presentation request user interface 200 may be pre-populated when the presentation request user interface 200 is displayed for the sales representative, if the sales representative has previously entered this information via the server 104 prior to executing the presentation engine 106. Additionally, the market field 204 may include a drop-down menu containing all available or recently used markets. According to the example shown in FIG. 2, the sales representative has selected “Cincinnati, Ohio” as the desired market.

The presentation request user interface 200 further includes a heading field 206. The heading field 206 corresponds to a marketing category, or heading, that best describes the business associated with the customer. The marketing category is similar to, and may mirror, the headings in a Yellow Pages directory that describe the type of businesses listed under the heading. The heading field 206 may also include a drop-down menu containing all available or recently used headings. According to the example shown in FIG. 2, the sales representative has selected “Accountants” as the desired name for heading field 206.

The sales representative may input the name of the customer in the advertiser name field 208. A customer ID may be input into the ID field 210 and the year of the directory in which the sales representative is attempting to sell advertisements may be entered into the year field 212. The sales representative selects a full template selector 214 or an abbreviated template selector 216 according to the type of presentation that the sales representative would like to create. As stated above, the abbreviated presentation template 116B is a condensed form of the full presentation template 116A and is used when calling a customer or any other situation in which the sales representative believes that the customer has limited time or motivation.

The remaining information to be entered via the presentation request user interface 200 is to be used in calculating the ROI estimates that demonstrate to the customer how much profit the customer can expect to receive from an investment made for purchasing advertising space within one or more print directories and/or Internet directories. With regards to print directories, investment information may be provided for core print directories, such as a comprehensive Yellow Pages directory, as well as for any companion directories, which include abbreviated and typically smaller versions of the comprehensive directory, if any companion directories are available for the market entered in the market field 204. The presentation request user interface 200 includes Yellow Pages fields 218 for entering, viewing, or amending data that is applicable to advertising in a Yellow Pages directory. If the presentation engine 106 determines that there is an Internet directory applicable to the market selected in the market field 204, then the presentation request user interface 200 will include Internet fields 220 for entering, viewing, or amending data that is applicable to advertising in the Internet directory.

The sales representative may enter monthly core investment information 222, monthly companion investment information 223, monthly calls/clicks information 224, customer conversion rate information 226, average customer worth information 228, and average profit per customer information 230 in the applicable Yellow Pages fields 218 and Internet fields 220. When the heading is selected in the heading field 206, the presentation engine 106 will search the repository database 110 for collateral data 108 associated with the selected heading. If any of the located collateral data 108 corresponds to the information 222, 223, 224, 226, 228, or 230, then the appropriate Yellow Pages fields 218 and Internet fields 220 are pre-populated with the corresponding collateral data 108. The sales representative has the opportunity to amend any of the pre-populated data with more accurate information pertaining to the specific customer or local market.

It should be understood that the presentation engine 106 may search the repository database 110 for collateral data 108 associated with the market selected in the market field 204 as well as for collateral data 108 associated with the heading selected in the heading field 206. Because reliable purchasing statistics are often compiled by data sources 112A, 112B, and 112C on a national level, collateral data 108 corresponding to a local market may not be available in the repository database 110. If the sales representative knows that any collateral data 108 based on nationwide studies or research is used to pre-populate any fields of the presentation request user interface 200 and that the pre-populated data is not accurate for the selected market, then the sales representative may amend the pre-populated data to reflect more accurate information. Alternatively, the sales representative may place zeros in any of the Yellow Pages fields 218 or Internet fields 220 to create an incomplete marketing presentation. The sales representative may at a later time replace the zeros with accurate data while speaking to a customer or after doing further research.

The monthly core investment information 222 corresponds to the amount of money that the sales representative is proposing that the customer spend per month on advertising in a core print directory such as the comprehensive Yellow Pages. The monthly companion investment information 223 corresponds to the amount of money that the sales representative is proposing that the customer spend per month on advertising in a companion directory. This amount may be a small increase over the price of advertising in the corresponding comprehensive directory. As an example, if a companion print directory is available in a given market, the same advertisement that is placed in the core print directory may be reduced 90 percent when placed in the companion print directory. The monthly calls/clicks information 224 reflects the number of monthly calls that a customer can expect to receive from a Yellow Pages print advertisement and the number of monthly clicks that the customer can expect to receive from an Internet advertisement. A click represents an instance in which a consumer selects the Internet advertisement to gather additional information.

The customer conversion rate information 226 reflects the percentage of those calls and clicks that the customer can expect to convert into a sale. The average customer worth information 228 is the amount of money that the customer can expect each consumer to spend on a sale. The average profit per customer information 230 corresponds to the amount of profit per consumer that the customer can expect to receive after expenses. The information 222, 223, 224, 226, 228, or 230 will be discussed in further detail below with respect to the illustrative marketing presentation shown in FIGS. 3A-3U. It should be understood that the presentation request user interface 200 is not limited to the data entry fields shown in FIG. 2. Rather, any number of data entry fields corresponding to any amount and type of data may be included within the presentation request user interface 200, depending on the information to be included within the resulting marketing presentation and the corresponding collateral data 108.

According to one embodiment, the sales representative may select an “Add Visuals” selector 231 in order to add additional slides to a presentation template 116. It should be appreciated that any number and type of visuals may be stored in the repository database 110 or any other storage location. When the “Add Visuals” selector 231 is selected, then a user interface is displayed that allows a sales representative to select one or more visuals to add to the presentation being created. The selected visuals will be retrieved and added to the end of the presentation template 116 by the presentation engine 106 when the presentation is created. In this manner, a sales representative may further customize a presentation for a potential advertiser by adding visuals that are appropriate for the potential advertiser or specific sales scenario.

Once the sales representative has completed all appropriate data entry fields of the presentation request user interface 200, then the sales representative may select the “Clear Values” button 232 to clear the data entry fields and begin again, or the “Create Presentation” button 234 to create a targeted marketing presentation using the information input into the presentation request user interface 200. Once the “Create Presentation” button 234 is selected, the presentation engine 106 retrieves the full presentation template 116A or the abbreviated presentation template 116B according to the sales representative's selection of either the full template selector 214 or the abbreviated template selector 216, as well as any selected visuals. The presentation templates 116A and 116B include markers for specific types of data and images to be inserted into the presentation at pre-determined locations. The presentation engine 106 searches the appropriate presentation template 116 for these markers and maps the appropriate data to the corresponding marker within the presentation template 116. It should be understood that the presentation templates 116A and 116B may perform this data mapping process using macros located within the corresponding presentation template 116 and executed by the presentation engine 106.

For example, the full presentation template 116A includes a marker corresponding to the advertiser name. The presentation engine 106 maps the data in the advertiser name field 208 of the presentation request user interface 200 into the corresponding marker location within the full presentation template 116. The presentation engine 106 performs this mapping action for all of the data entry location markers within the presentation template 116. Some of the markers require entry of the results of calculations to be made utilizing specific data entered into the presentation request user interface 200 or located within the repository database 110. Macros may be used to perform the required calculations.

FIGS. 3A-3U show sample presentation slides of a marketing presentation created according to one embodiment of the disclosure presented herein. FIG. 3A shows an introductory slide 302. The introductory slide 302 includes advertiser name information 304 and associated market information 306 corresponding to the advertiser name and market fields 208 and 204 of the presentation request user interface 200. Each slide of the marketing presentation includes a navigation bar 308. The navigation bar 308 contains categories that are hot-linked to the corresponding slides within the marketing presentation. FIGS. 3B-3F show slides 310A, 310B, 310C, 312, and 314 corresponding to multiple categories in the navigation bar 308. These slides 310A, 310B, 310C, 312, and 314 display collateral data 108 corresponding to local market and national statistics. The circled data throughout the sample marketing presentation shown in FIGS. 3A-3U represents the locations within the presentation which include data entry location markers in the corresponding full presentation template 116A. The data and images have been mapped to these locations, and as shown in the completed marketing presentation, include collateral data 108, data that has been entered into the presentation request user interface 200, and/or data that has been calculated using the collateral data 108 and the data from the presentation request user interface 200.

It should be appreciated from reviewing FIGS. 3A-3U the collateral data 108 corresponding to targeted statistical data is a valuable sales tool for persuading customers to purchase new products or services. It is important that these statistics be as up-to-date as possible. Because the collateral data 108 is updated within the repository database 110 as soon as it becomes available, and because the presentation engine 106 retrieves the applicable collateral data 108 from the repository database 110 for mapping into a presentation template 116 only when the sales representative requests a marketing presentation, the sales representative can be assured that the information within the resulting marketing presentation is the most current information available.

Returning now to the sample marketing presentation, FIG. 3G shows slide 316 corresponding to the “Your Market” category. This slide 316 includes collateral data 108 corresponding to the local market entered into the market field 204 of the presentation request user interface 200. Additionally, slide 316 includes a graph 318 corresponding to the collateral data 108. It should be appreciated that the graph 318 may have been created using a macro within the full presentation template 116A. Collateral data 108 and the results of related calculations may be displayed in any format including text, images, audio, and other media. FIG. 3H shows slide 320 corresponding to the “New Customers” category. This slide 320 includes statistical data corresponding to the national market. It should be appreciated how the statistical data retrieved from the repository database 110 may be utilized in calculations to arrive at targeted information such as the information shown in the boxed portion of the slide 320 and other boxed portions throughout the sample presentation. It should also be appreciated that the sources of the collateral data 108 are shown in one or more slides at the end of each presentation (not shown).

FIGS. 3I-3S show slides 322, 324A, 324B, 324C, 324D, 326, 330, 332A, 332B, and 332C, which further illustrate statistics from the collateral data 108 or calculated using the collateral data 108 that was placed within the full presentation template 116A to create the marketing presentation. FIG. 3T shows slide 334 corresponding to the “ROI-Customer Worth” category. This slide 334 outlines the calculations made to arrive at a customer's predicted print program ROI 336, the customer's predicted Internet program ROI 338, and a combined total ROI 340. According to one illustrative embodiment, the factors that are used to calculate the customer's projected ROI for print and/or Internet advertising include a number of projected monthly buyers, a monthly core investment amount, a monthly companion investment amount, an estimated number of monthly calls/clicks received, a customer conversion rate, and an average customer worth value may be modified by a sales representative while discussing the marketing presentation with a customer. The number of projected monthly buyers is calculated using the number of monthly buyers of products under the heading entered into the heading field 206 of the presentation request user interface 200, the percent of monthly buyers of products under the same heading that use the particular advertising medium, and the percent of monthly buyers in the market who use the particular advertising medium most often when purchasing a product.

The monthly core investment amount, the monthly companion investment amount, the estimated number of monthly calls/clicks received, the customer conversion rate, and the average customer worth are all populated with information entered into the presentation request user interface 200. These boxed fields may be modified by a sales representative while discussing the marketing presentation with a customer. In this manner, the sales representative may demonstrate the effect on the resulting ROI value when any of the variables are altered. This also allows the sales representative to alter the presentation in order to use the customer's actual sales data to arrive the most accurate ROI estimate possible.

The amount of investment per call/click is determined by dividing the monthly investment amount by the estimated number of monthly calls/clicks received. The actual sales from calls/clicks is determined by multiplying the estimated number of monthly calls/clicks received by the customer conversion rate. The net ROI is then calculated by multiplying the average customer worth by the actual sales from calls/clicks and then subtracting the monthly investment amount. Finally, the ROI percentage is determined by dividing the net ROI by the monthly investment amount. The total ROI 340 is determined similarly after combining the print program and Internet program values.

FIG. 3U shows slide 342, which displays the results of similar calculations to those made in slide 334 shown in FIG. 3T. However, in slide 342, the calculations made to arrive at a customer's predicted print program ROI 344, the customer's predicted Internet program ROI 346, and a combined total ROI 348 are based on the average profit per customer rather than the average customer worth. It should be understood that the presentation engine 106 may determine whether a companion directory exists for the market selected in the market field 204 of the presentation request user interface 200, and if a companion directory does not exists for the selected market, the presentation engine 106 may omit the monthly companion investment reference from the customer's predicted print program ROI 336 and the customer's predicted print program ROI 344 of slides 334 and 342, respectively. Each slide of the marketing presentation additionally includes links 350, 352, and 354 to a presentation home page, a calculator, and the Internet, respectively. It should also be understood that the disclosure presented herein is not limited to the number of slides shown in FIGS. 3A-3U or to the content of the marketing presentation described above. Any quantity and type of data and images may be utilized by the presentation engine 106 to create a marketing presentation according to the presentation template 116 created or chosen by a user.

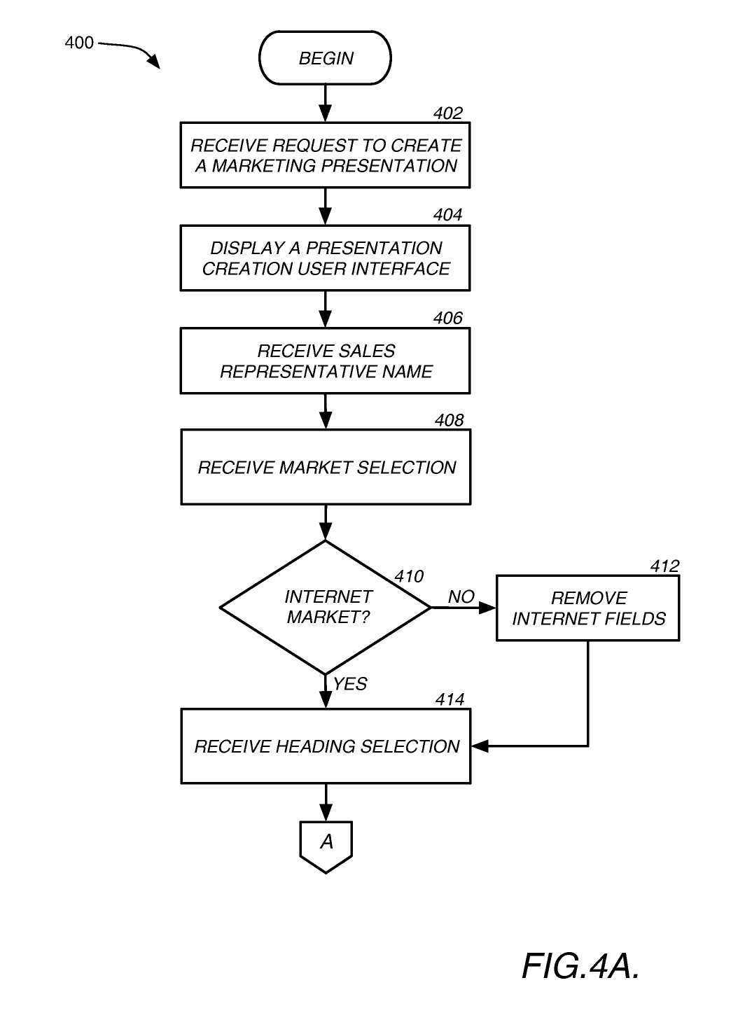

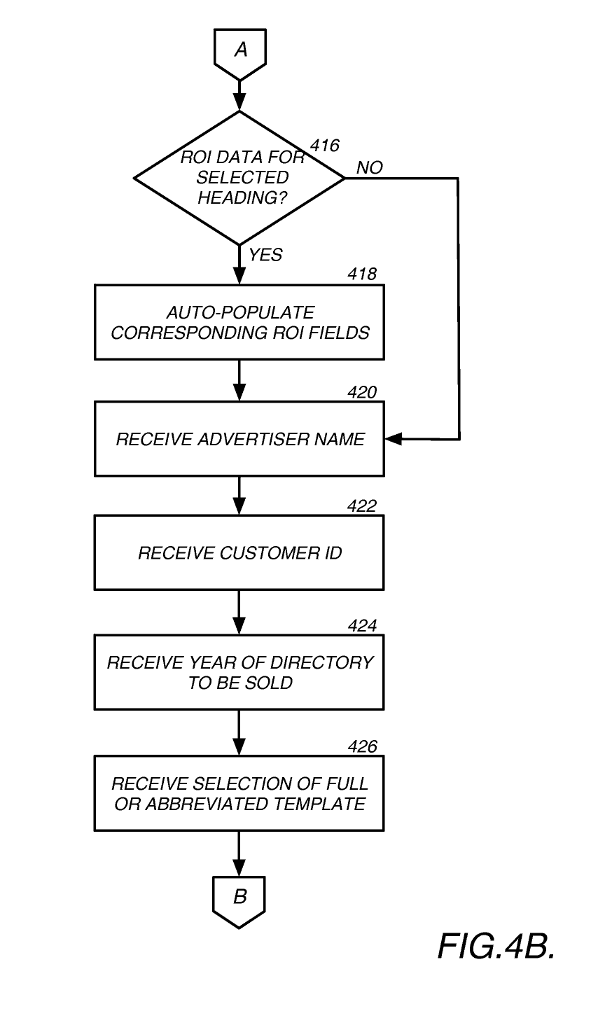

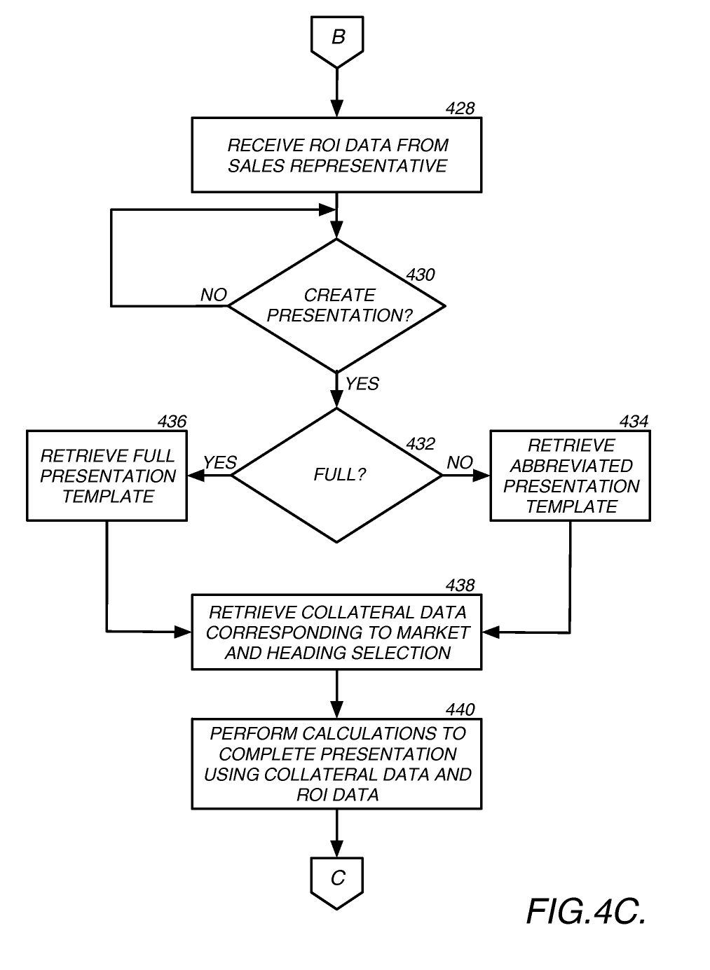

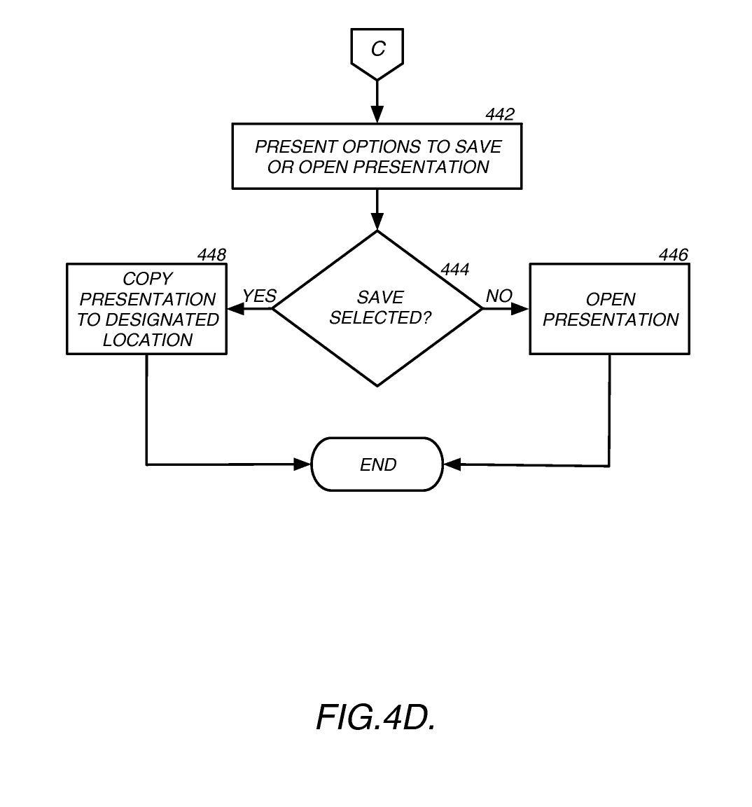

Turning now to FIGS. 4A-4D, an illustrative routine 400 will be described for creating a marketing presentation according to various embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 400 begins at operation 402, where the presentation engine 106 receives a request to create a marketing presentation. From operation 402, the routine continues to operation 404, where the presentation engine 106 provides the workstation 102 with a presentation request user interface 200 for gathering presentation data from the sales representative. It should be understood that the sales representative utilizes the workstation 102 to enter information into the presentation request user interface 200. The workstation 102 communicates with the server 104 on which the presentation engine 106 is executing. Alternatively, the sales representative may communicate directly with the server 104 and presentation engine 106 via one or more user input devices and a monitor connected directly to the server 104.

The routine 400 continues from operation 404 to operation 406, where the presentation engine 106 receives the name of the sales representative that is requesting the marketing presentation. This information may be incorporated into the marketing presentation and/or be used for identifying the sales representative that created the marketing presentation for tracking purposes. From operation 406, the routine 400 continues to operation 408, where the presentation engine 106 receives a market selection. As described above, the sales representative may select the desired market using a drop-down menu in the market field 204 of the presentation request user interface 200. Alternatively, the market may be sent from the workstation 102 to the presentation engine 106 with the initial request to create a presentation that triggered the presentation engine 106 to provide the presentation request user interface 200. In this latter scenario, the market field 204 may be pre-populated with the selected market.

From operation 408, the routine 400 continues to operation 410, where the presentation engine 106 determines whether the selected market includes an applicable Internet directory for which the sales representative would want to sell an advertisement. If there is an applicable Internet market, then the routine continues to operation 414, where the presentation engine 106 receives a heading selection. However, if the presentation engine 106 determines at operation 410 that there is not an applicable Internet market, then the routine 400 proceeds to operation 412, where the Internet fields 220 are removed from the presentation request user interface 200 prior to continuing to operation 414. At operation 414, the presentation engine 106 receives a marketing category, or heading, from the heading field 206 of the presentation request user interface 200.

The routine continues from operation 414 to operation 416, where the presentation engine 106 determines whether there is any applicable ROI data in the repository database 110 corresponding to the selected heading that can be entered into the Yellow Pages fields 218 or the Internet fields 220 of the presentation request user interface 200. As described above, the applicable ROI data might include monthly core investment information 222, monthly companion investment information 223, monthly calls/clicks information 224, customer conversion rate information 226, average customer worth information 228, and average profit per customer information 230. If the presentation engine 106 determines that there is not applicable ROI data in the repository database 110 for the selected heading, then the routine 400 proceeds to operation 420 and continues as described below. However, if the presentation engine 106 determines at operation 416 that there is applicable ROI data in the repository database 110 for the selected heading, then the routine 400 continues to operation 418, where the presentation engine 106 auto-populates the Yellow Pages fields 218 and the Internet fields 220 with the corresponding ROI data.

From operation 418, the routine 400 continues to operation 420, where the presentation engine 106 receives the advertiser's name. The presentation engine 106 will insert this name into the introductory slide 302 of the marketing presentation. The routine 400 continues to operation 422, where the presentation engine 106 receives a customer ID that may be used for template storage or tracking purposes. From operation 422, the routine 400 continues to operation 424, where the presentation engine 106 receives a year corresponding to the directories for which the sales representative is attempting to sell advertisements. Similarly, this data may be displayed within the marketing presentation or may be used for tracking or management purposes.

The routine 400 continues to operation 426, where the presentation engine 106 receives a selection corresponding to whether the sales representative would like to create a full marketing presentation or an abbreviated marketing presentation. This selection, indicated via the full template selector 214 or the abbreviated template selector 216 of the presentation request user interface 200, determines whether the presentation engine 106 utilizes the full presentation template 116A or the abbreviated presentation template 116B, as will be described below. It should be appreciated that any number and type of presentation templates 116 may be retrieved from the template storage 114 to create a desired type of presentation that is targeted to a specific advertiser and type of advertisement.

From operation 426, the routine 400 continues to operation 428, where the presentation engine 106 receives ROI data from the sales representative in the Yellow Pages fields 218 and the Internet fields 220 or the presentation request user interface 200 that was not auto-populated by the presentation engine 106 at operation 418 above. It should be appreciated that the sales representative may amend any data in Yellow Pages fields 218 or the Internet fields 220 that were populated by the presentation engine 106 in order to more accurately reflect data associated with the specifically targeted advertiser. The routine 400 continues from operation 428 to operation 430, where the presentation engine 106 determines whether the “Create Presentation” button 234 has been selected. If not, then the routine 400 awaits further input or the selection of the “Create Presentation” button 234. However, if the “Create Presentation” button 234 is selected by the sales representative, then the routine continues to operation 432, where the presentation engine 106 determines from the full template selector 214 and the abbreviated template selector 216 whether the sales representative would like to create a full marketing presentation or an abbreviated marketing presentation.

If the abbreviated template selector 216 was chosen, then the presentation engine 106 retrieves the abbreviated presentation template 116B at operation 434. However, if the full template selector 214 was chosen, then the presentation engine 106 retrieves the full presentation template 116A at operation 436. From operations 434 and 436, the routine proceeds to operation 438, where the presentation engine 106 retrieves any appropriate collateral data 108 corresponding to the market and heading selections entered into the market field 204 and the heading field 206. The routine 400 continues from operation 438 to operation 440, where the presentation engine 106 performs any necessary calculations to complete the presentation template 116. Example calculations are described above with respect to FIGS. 3A-3U.

From operation 440, the routine 400 continues to operation 442, where the presentation engine 106 presents the sales representative with options to save the completed marketing presentation or to open the presentation. At operation 444, the presentation engine 106 determines if the sales representative selected the option to save the presentation. If the sales representative selected the option to save the presentation, then the routine proceeds to operation 448, where the presentation engine 106 copies the completed marketing presentation to a designated location on the workstation 102, the server 104, or any other designated location or device and the routine 400 ends. It should be appreciated that the presentation may be saved in a read-only format such that it may not be altered once created and saved. Alternatively, the presentation may be password protected such that only authorized personnel may edit the presentation content. Returning to operation 444, if the presentation engine 106 determines that the sales representative selected the option to open the presentation, then the routine proceeds to operation 446, where the presentation engine 106 opens the completed marketing presentation and the routine 400 ends.

Referring now to FIG. 5, an illustrative computer architecture for a computer 500 utilized in the various embodiments presented herein will be discussed. The computer architecture shown in FIG. 5 illustrates a conventional desktop, laptop computer, or server computer. The computer architecture shown in FIG. 5 includes a central processing unit 502 (CPU), a system memory 508, including a random access memory 514 (RAM) and a read-only memory (ROM) 516, and a system bus 504 that couples the memory to the CPU 502. A BIOS containing the basic routines that help to transfer information between elements within the computer 500, such as during startup, is stored in the ROM 516. The computer 500 further includes a mass storage device 510 for storing an operating system 518, application programs, and other program modules, which will be described in greater detail below.

The mass storage device 510 is connected to the CPU 502 through a mass storage controller (not shown) connected to the bus 504. The mass storage device 510 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available media that can be accessed by the computer 500.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network 501. The network 501 may include a wireless network such as, but not limited to, a Wireless Local Area Network (WLAN) such as a WI-FI network, a Wireless Wide Area Network (WWAN), a Wireless Personal Area Network (WPAN) such as BLUETOOTH, a Wireless Metropolitan Area Network (WMAN) such a WiMAX network, a cellular network, or a satellite network. Alternatively, the network 501 may be a wired network such as, but not limited to, a wired Wide Area Network (WAN), a wired Local Area Network (LAN) such as the Ethernet, a wired Personal Area Network (PAN), or a wired Metropolitan Area Network (MAN). The network 501 may include the Internet such that the elements of the marketing system 100 communicate with one another via wireless or wired connections to the Internet.

The computer 500 may connect to the network 501 through a network interface unit 506 connected to the bus 504. It should be appreciated that the network interface unit 506 may also be utilized to connect to other types of networks and remote computer systems. The computer 500 may also include an input/output controller 512 for receiving and processing input from a number of other devices, including a keyboard, mouse, or electronic stylus (not shown in FIG. 5). Similarly, an input/output controller may provide output to a display screen, a printer, or other type of output device (also not shown in FIG. 5).

As mentioned briefly above, a number of program modules and data files may be stored in the mass storage device 510 and RAM 514 of the computer 500, including an operating system 518 suitable for controlling the operation of a networked desktop or server computer, such as the WINDOWS XP or WINDOWS VISTA operating systems from MICROSOFT CORPORATION of Redmond, Wash. Other operating systems, such as the LINUX operating system or the OSX operating system from APPLE COMPUTER, INC. may be utilized. It should be appreciated that the implementations presented herein may be embodied using a desktop or laptop computer or any other computing devices or systems or combinations thereof.

The mass storage device 510 and RAM 514 may also store one or more program modules. In particular, the mass storage device 510 and the RAM 514 may store a presentation engine 106, collateral data 108, one or more presentation templates 116, and the other program modules described above with respect to FIG. 1. Based on the foregoing, it should be appreciated that systems, methods, and computer-readable media for creating a template-based targeted marketing presentation are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method of creating a targeted marketing presentation, comprising:
receiving a marketing category;
retrieving collateral data corresponding to the marketing category;
retrieving a presentation template comprising sales information and a plurality of data insertion locations;
calculating at least one marketing estimate corresponding to a business within the marketing category using the collateral data; and
populating at least one data insertion location within the presentation template with the at least one marketing estimate to create the targeted marketing presentation.

2. The method of claim 1, wherein the marketing estimate comprises a Return On Investment (ROI) estimate.

3. The method of claim 2, further comprising receiving a market selection, wherein the market selection comprises a geographic area to be targeted by the business.

4. The method of claim 3, wherein the collateral data further corresponds to the market selection.

5. The method of claim 2, further comprising receiving actual sales data associated with the business, and wherein calculating the at least one ROI estimate corresponding to the business within the marketing category using the collateral data comprises calculating at least one ROI estimate corresponding to the business within the marketing category using the collateral data and the actual sales data.

6. The method of claim 1, further comprising:
displaying a user interface comprising fields for entering the marketing category and business information;
populating a plurality of data fields with the collateral data; and
receiving a request to create the targeted marketing presentation.

7. The method of claim 1, wherein the collateral data comprises a customer conversion rate, an average customer worth, and an average profit per customer.

8. The method of claim 1, wherein the collateral data is retrieved from a database that comprises third-party data that is directly updated as it becomes available.

9. The method of claim 1, wherein the plurality of data insertion locations are further populated with at least a portion of the collateral data.

10. The method of claim 1, wherein the at least one marketing estimate corresponds to Yellow Pages and Internet advertising.

11. A computer-readable medium having computer-executable instructions stored thereon which, when executed by a computer, cause the computer to:
receive a marketing category;
retrieve collateral data corresponding to the marketing category;
retrieve a presentation template comprising sales information and a plurality of data insertion locations;
calculate at least one ROI estimate corresponding to a business within the marketing category using the collateral data; and
populate at least one data insertion location within the presentation template with a ROI estimate to create a targeted marketing presentation.

12. The computer-readable medium of claim 11, further comprising computer-executable instructions stored thereon which, when executed by a computer, cause the computer to receive a market selection comprising a geographic area to be targeted by the business, and wherein the collateral data further corresponds to the market selection.

13. The computer-readable medium of claim 11, wherein the marketing category corresponds to a heading within an advertising directory, wherein the collateral data comprises an average amount of profit per customer, and wherein the at least one ROI estimate comprises a net return on advertising investments utilizing the average amount of profit per customer.

14. The computer-readable medium of claim 11, further comprising computer-executable instructions stored thereon which, when executed by a computer, cause the computer to receive actual sales data associated with the business, and wherein causing the computer to calculate the at least one ROI estimate corresponding to the business within the marketing category using the collateral data comprises causing the computer to calculate at least one ROI estimate corresponding to the business within the marketing category using the collateral data and the actual sales data.

15. The computer-readable medium of claim 11, further comprising computer-executable instructions stored thereon which, when executed by a computer, cause the computer to:
display a user interface comprising fields for entering the marketing category and business information;
populate a plurality of data fields with the collateral data; and
receive a request to create the targeted marketing presentation.

16. The computer-readable medium of claim 11, wherein the collateral data comprises a customer conversion rate, an average customer worth, and an average profit per customer.

17. A system for creating a targeted marketing presentation, comprising:
means for receiving a marketing category;
means for retrieving collateral data corresponding to the marketing category;
means for retrieving a presentation template comprising sales information and a plurality of data insertion locations;
means for calculating at least one ROI estimate corresponding to a business within the marketing category using the collateral data; and
means for populating at least one data insertion location within the presentation template with a ROI estimate to create the targeted marketing presentation.

18. The system of claim 17, further comprising means for receiving a market selection comprising a geographic area to be targeted by the business, and wherein the collateral data further corresponds to the market selection.

19. The system of claim 17, wherein the marketing category corresponds to a heading within an advertising directory, wherein the collateral data comprises an average amount of profit per customer, and wherein the at least one ROI estimate comprises a net return on advertising investments utilizing the average amount of profit per customer.

20. The system of claim 17, further comprising:
means for displaying a user interface comprising fields for entering the marketing category and business information;
means for populating a plurality of data fields with the collateral data; and
means for receiving a request to create the targeted marketing presentation.
